(19) United States
(12) Patent Application Publication
(10) Pub. No.: US 2009/0276411 A1
(43) Pub. Date: Nov. 5, 2009

(54) ISSUE TREND ANALYSIS SYSTEM

(76) Inventors: Jung-Ho Park, Anyang-si (KR); Jung-Pil Ha, Seoul (KR)

Correspondence Address: SCHMEISER OLSEN & WATTS, 18 E UNIVERSITY DRIVE, SUITE # 101, MESA, AZ, 85201, US

(21) Appl. No.: 11/913,548

(22) PCT Filed: May 25, 2005
(86) PCT No.: PCT/KR05/01531

§ 371 Date: Nov. 2, 2007

(30) Foreign Application Priority Data
May 4, 2005 (KR) 10-2005-0037722

(51) Int. Cl. G06F 17/30

(52) U.S. Cl. 707/5; 707/E17.109

(57) ABSTRACT

A system of analyzing a large document-based propensity over a query language is disclosed. In the system of analyzing the large document-based propensity over the query language, the correlated words and sentences on the query language inputted by the user are searched on the basis of large on-line or off line documents and the general report of analyzing the relationship among the words of the corresponding documents, the propensity of the words and the sentences, the appearance frequency of the recent words and sentences and so on is provided to the user, whereby it can previously predict the propensity (the positive image, the negative image or Non-Applicable), the related word based on the importance and the tendency change through the result of the large document analysis generating for a recent predetermined period according to the query language of the user.

### TECHNICAL FIELD

Analyzing a large document-based propensity over a query language, and more particularly to a system of analyzing a large document-based propensity over a query language capable of searching correlated words and sentences on a query language inputted by a user on the basis of large documents and providing a general report of analyzing a relationship among the words of the corresponding documents, a propensity of each word and sentence and the appearance frequency of the recent words and sentences and so on to the user.

### BACKGROUND ART

Generally, when the user inputs the query language through an Internet, he cannot check out the appearance frequency number on the desirous query language of the user and cannot grasp as to whether the propensity of the query language is positive or negative.

Accordingly, in case that the propensity (the positive image, the negative image and so on) on the query language inputted by the user is not clearly recognized, it is the only thing the user can search the document including the simple query.

### DISCLOSURE OF INVENTION

### Technical Problem

Accordingly, the present invention has been made to solve the above-mentioned problems occurring in the prior art, and an object of the present invention is to provide a system of analyzing a large document-based propensity over a query language capable of searching correlated words and sentences on a query language inputted by a user on the basis of large documents and providing a general report of analyzing a relationship among words of the corresponding documents, a propensity of each word and sentence and the appearance frequency of the recent words and sentences and so on to the user.

### Technical Solution

To accomplish the object, the present invention provides a the system of analyzing a large document-based propensity over a query language comprising a document collecting portion for collecting and classifying on-line web documents and storing in a document DB; a document scanning portion for scanning off-line documents and storing to a file; a document recognition portion for recognizing the document from the scanned file and storing a text document in the document DB; the document DB for classifying and storing the collected on-line web documents or the documents added in real time through a document recognition or a direct input and so on by means of a keyword, next to the scanning of the off-line documents; a query language input portion for inputting at least one desirous word by means of a user; a sentence obtaining portion for obtaining words and sentences from the document DB through the keyword on the query inputted by the user and saving in a buffer; a word/sentence classification portion for classifying by similar items from the obtained words and sentences; a relationship/importance analysis portion for analyzing a relationship and an importance among the classified words and sentences; a representative sentence generating portion for generating a representative sentence in the automatically classified words and sentences family; a propensity controlling portion for giving a point according to an affirmative word, a negative word and each word based on the words in the documents in order to operate the propensity on the words and the sentences corresponding to each sentences family; a propensity word DB for classifying into the affirmative word and the negative word and storing propensity points of each word; and an analysis result output portion for presenting propensity points of the representative sentence and the sentences family including the representative sentence.

Preferably, the relationship/importance analysis portion judges the importance and decides a ranking on the basis of the relationship between the query language and the index language, the exposed frequency number and the weight of the documents.

Preferably, the propensity controlling portion for analyzing the propensity judges the affirmative propensity or the negative one on the word extracted from the documents having the query language with reference to the propensity word DB.

Preferably, the analysis result output portion generates the importance and the propensity by a period of time on the keyword or the sentences more continuous with the query language from the large documents.

### Advantageous Effects

As can be seen from the foregoing, in the system of analyzing a large document-based propensity over a query language, there is an effect in that the correlated words and sentences on the query language inputted by the user are searched on the basis of large on-line or off line documents and the general report of analyzing the relationship among the words of the corresponding documents, the propensity of the words and the sentences, the appearance frequency of the recent words and sentences and so on is provided to the user, whereby it can previously predict the propensity (the positive image, the negative image or Non-Applicable), the related word based on the importance and the tendency change through the result of the large document analysis generating for a recent predetermined period according to the query language of the user.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a schematic block diagram illustrating a system of analyzing a large document-based propensity over a query language according to the present invention;

FIG. 2 is a first example view illustrating a screen of displaying to a questioner over a query language according to one embodiment of the present invention; and

FIG. 3 is a second example view illustrating a screen of displaying to a questioner over a query language according to another embodiment of the present invention.

### BEST MODE FOR CARRYING OUT THE INVENTION

A preferred embodiment of the invention will be described in detail below with reference to the accompanying drawings.

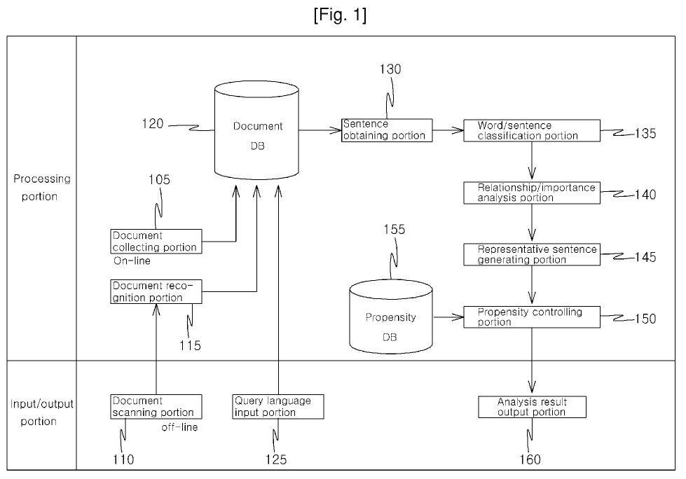

FIG. 1 is a schematic block diagram illustrating a system of analyzing a large document-based propensity over a query language according to the present invention.

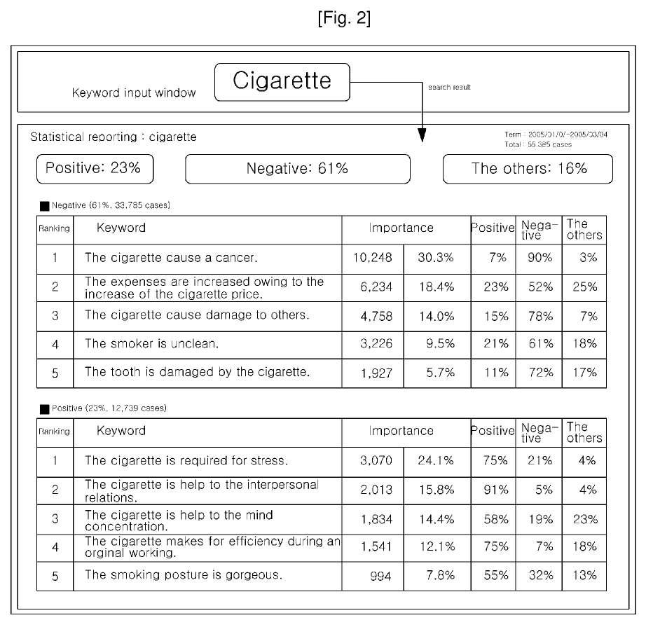

FIG. 2 is a first example view illustrating a screen of displaying to a questioner over a query language according to one embodiment of the present invention.

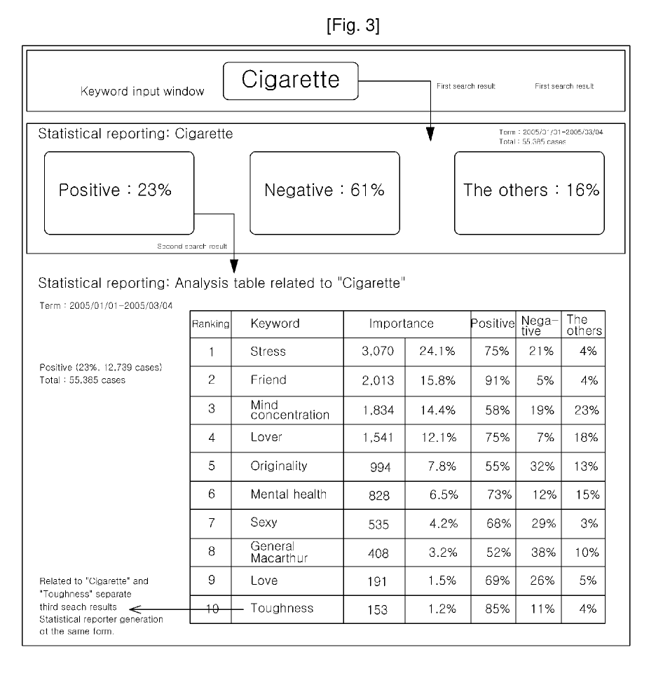

FIG. 3 is a second example view illustrating a screen of displaying to a questioner over a query language according to another embodiment of the present invention.

As shown in FIG. 1, the system of analyzing the large document-based propensity over the query language according to the present invention includes a document collecting portion 105 for collecting and classifying on-line web documents and storing in a document DB 120; a document scanning portion 110 for scanning off-line documents and storing them as a file; a document recognition portion 115 for recognizing the document from the scanned file and storing a text document in the document DB 120; the document DB 120 for classifying and storing the collected on-line web documents or the documents added in real time through a document recognition or a direct input and so on next to the scanning of the off-line documents by means of a keyword; a query language input portion 125 for inputting at least one desirous word by means of a user; a sentence obtaining portion 130 for obtaining words and sentences from the document DB 120 through the keyword on the query inputted by the user and saving in a buffer; a word/sentence classification portion 135 for classifying by similar items from the obtained words and sentences; a relationship/importance analysis portion 140 for analyzing a relationship and an importance among the classified words and sentences; a representative sentence generating portion 145 for generating a representative sentence in the automatically classified words and sentences family; a propensity controlling portion 150 for giving a point according to an affirmative word, a negative word and each word based on the words in the documents in order to operate the propensity on the words and the sentences corresponding to each sentences family; a propensity word DB 155 for classifying into the affirmative word and the negative word and storing propensity points of each word; and an analysis result output portion 160 for presenting propensity points of the representative sentence and the sentences family including the representative sentence.

The document collecting portion 105 serves to collect and classify the on-line web documents through a robot engine and store the documents in the document DB 120. Here, since this technique is already well-known in public, the description on the related techniques is omitted here.

The document recognition portion 115 serves to recognize the file scanned through the document scanning portion 110 and stores the text documents in the document DB 120. Accordingly, the web documents and the text documents are classified by the keyword and stored in the document DB 120.

The scanned file is recognized through the document recognition portion 115 and the recognized file is converted into a text. A document processing automatic technique used in this case recognizes print and cursive numerals, an English writing, a Korean writing and so on by using a multi OCR manner (including a structural OCR and statistical OCR), so that it can provide a high recognition ratio of about 99% and a rapid speed. Accordingly, a qualitative recognition is possible according to a user designation, thereby it can provide a convenience to the user.

More concretely, in a shape recognition of the documents, various document forms are classified according to an automatic recognition and a classification order set by a manager or attached documents are classified according to a judgment of the user (input person). Also, a writing paper is automatically recognized to generate one image document on a case-by-case basis. In this case, uncertain subjects or wrong forms among the recognized results are checked and revised through a mistake table and the recognized results and the supplement are divided and revised while viewing each image.

In the meantime, in a shape output thereof, various forms are automatically recognized and the repeated forms are eliminated to quickly extract only necessary information.

Also, the quality of the data is improved in order to increase the accuracy of the OCR and the ICR. Moreover, a module capable of recognizing the forms without the position of the recognition object or the contamination thereof is mounted thereon.

The relationship/importance analysis portion 140 judges the importance and decides the ranking on the basis of the relationship between the query language and the index language, the exposed frequency number and the weight of the documents.

The propensity controlling portion 150 for analyzing the propensity judges the affirmative propensity or the negative one on the word extracted from the documents having the query language with reference to the propensity word DB 155.

The analysis result output portion 160 generates the importance and the propensity by a period of time on the keyword or the sentences more continuous with the query language from the large documents.

Each element of the present invention will be described in detail below with reference to FIG. 1 through FIG. 3.

The query language input portion 125 inputs at least one desirous word by means of the user. For example, the user inputs “cigarette” as the query language through the query language input portion 125.

If the word “cigarette” is inputted in the query language input portion 125, the document including the keyword “cigarette” are searched in the document DB 120 and then, the words and the sentences necessary for the analysis are extracted from each document to be temporarily stored. As shown in FIG. 2, the documents of 55,385 cases are searched.

Referring to FIG. 2, in the word/sentence classification portion 135 for classifying by similar items from the obtained words and sentences, the documents including “cigarette” and “stress” are 3,070 cases among the total documents and the documents including “cigarette” and “friend” are 2,013 cases among the total documents.

In the word/sentence classification portion 135, the similarity inspection is the criterion of the keyword and it classifies the obtained words and sentences by using a noun, an adjective, an original form of a verb and so on.

The word/sentence classification portion 135 registers the noun, the adjective and the original form of the verb as the index language in order to utilize them during the search of the user.

The relationship/importance analysis portion 140 judges the importance and decides the ranking on the basis of the relationship between the query language and the index language, the exposed frequency number and the weight of the documents.

The representative sentence generating portion 145 serves to generate the representative sentences in the automatically classified words and sentences family. Referring to FIG. 2, the sentence of highest frequency as the representative sentence is extracted from the sentences having the keyword “cigarette”. That is, as shown in FIG. 2, the representative sentences, for example “cigarette causes a cancer”, “cigarette is required for the stress” and so forth.

The propensity analysis described in the present invention means that it restores the original forms of the adjective and the verb used in the sentences on the subject word (the noun as the subject) in one sentence unit or a document unit more than that and checks out as to whether the image propensity is positive or negative on the basis of the propensity word DB 155 on the restored original forms of the adjective and the verb.

The propensity controlling portion 150 serves to give the point according to the affirmative word, the negative word and each word based on the words in the documents in order to operate the propensity on the words and the sentences corresponding to each sentences family. Referring to FIG. 2, the sentences family classified into “cigarette” and “stress” are 3,070 cases and the representative sentence is “a cigarette is required for the stress”.

Here, it operates each propensity point on the pertinent sentences and calculates the overall average. For example, where “it is said that the cigarette is the best for solving stress” or “if the stifling mind is carried and sent through the cloud of smoke, it seems to feel more refreshed” are extracted, “cigarette”, “stress”, “solve”, “best”, “smoke”, “blow”, “stifle”, “mind”, “carry”, “send”, “feel” and “cool” as the keywords are extracted.

In the propensity word DB 155 for classifying into the affirmative word and the negative word and storing propensity points of each word, the propensity points of “cigarette”, “stress”, “solve”, “best”, “smoke”, “blow”, “stifle”, “mind”, “carry”, “send”, “feel” and “cool correspond to “negative 5”, “negative 5”, “positive 12”, “positive 7”, “0”, “0”, “negative 8”, “0”, “0, “negative 1”, “positive 7”, “0”, respectively. Accordingly, the calculating result is ?5−5+12+7+0+0−8+0+0−1+7+0=7. The propensity of the example sentence has the positive 7.

As described above, all documents related to the “cigarette” has the propensity of the positive 75 through the point conversion, the importance thereof, the adding and the calculating of the average.

In the representative sentences shown in FIG. 2, the sentences contained in the representative sentences are extracted through a statistical approach method and words having a high importance. In this case, the similarity among the sentences uses an inner product while the importance of the sentences uses the similarity. As described above, it can classify the sentences by using the noun, the adjective, the original form of a verb and so on.

The propensity analysis described in the present invention means that it restores the original forms of the adjective and the verb used in the sentences on the subject word (the noun as the subject) in one sentence unit or a document unit more than that and grasps as to whether the propensity is positive or negative (or approval/objection) on the basis of the propensity word DB 155 on the restored original forms of the adjective and the verb.

In conclusion, the correlated words and sentences on the query language inputted by the user are searched on the basis of large on-line or off line documents and the general report of analyzing the relationship among the words of the corresponding documents, the propensity of the words and the sentences, the appearance frequency of the recent words and sentences and so on is provided to the user, thereby it can previously predict the propensity (the positive image, the negative image and so on), the related word based on the importance and the tendency change through the result of the large document analysis generating for a recent predetermined period according to the query language of the user.

### INDUSTRIAL APPLICABILITY

As can be seen from the foregoing, in the system of analyzing the large document-based propensity over the query language, it can search correlated words and sentences on a query language inputted by the user on the basis of large documents and provide the general report of analyzing the relationship among the words of the corresponding documents, the propensity of the words and the sentences and the appearance frequency of the recent words and sentences and so on to the user.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

1. A the system of analyzing a large document-based propensity over a query language comprising:
a document collecting portion for collecting and classifying an on-line web document and storing in a document DB;
a document scanning portion for scanning off-line a document and storing it as a file;
a document recognition portion for recognizing the document from the scanned file and storing a text document in the document DB;
the document DB for classifying and storing the collected on-line web document or the document added in real time through a document recognition or a direct input and so on by means of a keyword, next to the scanning of the off-line documents;
a query language input portion for inputting at least one desirous word by means of a user;
a sentence obtaining portion for obtaining words and sentences from the document DB through the keyword on the query inputted by the user and saving in a buffer;
a word/sentence classification portion for classifying by similar items from the obtained words and sentences;
a relationship/importance analysis portion for analyzing a relationship and an importance among the classified words and sentences;
a representative sentence generating portion for generating a representative sentence in the automatically classified words and sentences family;
a propensity controlling portion for giving a point according to an affirmative word, a negative word and each word based on the words in the documents in order to operate the propensity on the words and the sentences corresponding to each sentences family;
a propensity word DB for classifying into the affirmative word and the negative word and storing propensity points of each word; and
an analysis result output portion for presenting propensity points of the representative sentence and the sentences family including the representative sentence.

2. A the system of analyzing a large document-based propensity over a query language as claimed in claim 1, wherein the relationship/importance analysis portion judges the importance and decides a ranking on the basis of the relationship between the query language and the index language, the exposed frequency number and the weight of the documents.

3. A the system of analyzing a large document-based propensity over a query language as claimed in claim 1, wherein the propensity controlling portion for analyzing the propensity judges the affirmative propensity or the negative one on the word extracted from the documents having the query language with reference to the propensity word DB.

4. A the system of analyzing a large document-based propensity over a query language as claimed in claim 1, wherein the analysis result output portion generates the importance and the propensity by a period of time on the keyword or the sentences more continuous with the query language from the large documents.
